(19) United States
(12) Patent Application Publication
(10) Pub. No.: US 2012/0005684 A1
(43) Pub. Date: Jan. 5, 2012

(54) PRIORITY ROLLBACK PROTOCOL

(75) Inventor: Lukasz Ziarek, Indianapolis, IN (US)

(73) Assignee: FIJI SYSTEMS, INC., Indianapolis, IN (US)

(21) Appl. No.: 13/173,293

(22) Filed: Jun. 30, 2011

Related U.S. Application Data
(60) Provisional application No. 61/398,841, filed on Jul. 2, 2010.

(51) Int. Cl. G06F 9/46

(52) U.S. Cl. 718/103; 718/102

(57) ABSTRACT

Mechanisms for enforcing limits to resource access are provided. In some embodiments, synchronization tools are used to reduce the worst case execution time of selected processing sequences. In one example, instructions from a first processing sequence are rolled back using rollback information stored in a data structure if a higher priority processing sequence seeks access to the resource.

### CROSS REFERENCE TO RELATED APPLICATION

The present application claims the benefit of U.S. Provisional Patent Application No. 61/398,841 filed Jul. 2, 2010, titled “PRIORITY ROLLBACK PROTOCOL,” the entire disclosure of which is expressly incorporated herein by reference.

### FIELD OF THE DISCLOSURE

The disclosure relates generally to mechanisms for enforcing limits to resource access by multiple processing sequences. More particularly, the disclosure relates to systems and methods in which synchronization mechanisms are used to reduce the worst case execution time of selected processing sequences.

### BACKGROUND OF THE DISCLOSURE

Synchronization mechanisms, including locks, can be used to prevent concurrent access to shared resources. Priority inversion occurs when a low priority thread locks a resource required by a high priority thread, effectively stalling the high priority thread until the low priority thread releases the shared resource. Moreover, in some systems intermediate threads that do not contend on the lock shared by the high and low priority threads can be scheduled ahead of the high priority thread while the lock is held by the low priority thread, enabling the medium priority thread to execute ahead of the high priority thread, indirectly preempting it. The problem of priority inversion is exacerbated when multiple threads and nested locks extend the unavailability of the shared resources.

When priority inversion occurs, it is difficult and costly to analyze the worst case execution time of the system. Priority inversion can cause an unacceptable delay for the high priority thread and, in the worst case, can result in a deadline miss. Abstractly, the worst case execution time for the high priority thread is the worst case execution time for its critical region plus the worst case execution time for the largest critical region of lower priority threads protected by the same lock. The costs and drawbacks associated with priority inversion can limit the utility of mixed criticality systems. New methods and systems are desirable which reduce worst case execution time analysis costs, worst case execution times, and which reduce the latency and increase execution predictability for high priority threads that acquire contended resources from lower priority threads.

### SUMMARY

A method and a system for controlling access to a resource are disclosed herein. In one embodiment of the method, the method is executable with a processing device according to processing instructions embedded in a non-transitory computer readable medium to prevent concurrent access to a software resource by a first thread and a second thread. In the present embodiment, the method comprises executing a critical region of the first thread; writing rollback information to a rollback data structure based on the executing of the critical region of the first thread; detecting an indication that the second thread seeks access to the software resource; and, after detecting the indication, rolling back the executing of the critical region of the first thread. In one variation thereof, the method further comprises the step of controlling operation of a hardware resource with the software resource. In another variation, the first thread has a lower priority than the second thread, and rolling back the executing of the critical region reduces a worst case execution time of the second thread. In a further variation, the critical region comprises a portion of the first thread protected by a synchronization tool and configured to modify the software resource.

In another embodiment of the method, the method is executable with a processing device according to processing instructions embedded in a non-transitory computer readable medium to prevent concurrent access to a software resource by a first processing sequence and a second processing sequence. In the present embodiment, the method comprises executing the first processing sequence with the processing device; writing rollback information to a rollback data structure based on the first processing sequence; detecting an indication that the second processing sequence seeks access to the software resource; and, after detecting the indication, rolling back the executing of the first processing sequence. In one variation thereof, the rollback data structure is a buffer and the step of rolling back the executing of the first processing sequence includes releasing a synchronization tool without flushing the buffer. In another variation, the rollback data structure is a log and the step of rolling back the executing of the first processing sequence includes flushing the log.

In a further embodiment according to the disclosure, a non-transitory computer-readable medium operable by a processing device to prevent concurrent access to a software resource by a first processing sequence and a second processing sequence is provided. The non-transitory computer-readable medium comprises a plurality of processing sequences embedded therein including a third processing sequence configured for writing rollback information to a rollback data structure based on execution of the first processing sequence; a fourth processing sequence configured for detecting an indication that the second processing sequence seeks access to the software resource; and a fifth processing sequence configured for rolling back the execution of the first processing sequence after detecting the indication.

In a yet further embodiment according to the disclosure, a system configured to prevent concurrent access to a software resource is provided. The system comprises a support structure; a hardware resource supported by the support structure; a processing device supported by the support structure, the processing device adapted for executing a first processing sequence and a second processing sequence; a non-transitory computer-readable medium supported by the support structure; and a plurality of processing sequences embedded in the non-transitory computer-readable medium including a third processing sequence adapted for writing rollback information to a rollback data structure based on the first processing sequence; a fourth processing sequence configured for detecting an indication that the second processing sequence seeks access to the software resource; and a fifth processing sequence configured for rolling back the execution of the first processing sequence after detecting the indication.

### BRIEF DESCRIPTION OF THE DRAWINGS

The above-mentioned and other disclosed features, and the manner of attaining them, will become more apparent and will be better understood by reference to the following description of disclosed embodiments taken in conjunction with the accompanying drawings, wherein:

FIG. 1 is a schematic diagram of an embodiment of a system according the disclosure;

FIG. 2 is a block diagram depicting the system of FIG. 1;

FIG. 3 is a block diagram illustrating a process exhibiting priority inversion;

FIG. 4 is a block diagram depicting an embodiment of a priority rollback protocol according to the disclosure;

FIG. 5 is a flow chart depicting another embodiment of a priority rollback protocol according to the disclosure;

FIGS. 6 and 7 are block diagrams depicting write buffering according to the embodiment depicted in FIG. 5;

FIG. 8 is a flow chart depicting a further embodiment of a priority rollback protocol according to the disclosure;

FIGS. 9-11 are block diagrams depicting write logging according to the embodiment depicted in FIG. 8;

FIG. 12 is a table comparing buffering and logging costs;

FIG. 13 is block diagram of an embodiment of a rollback method in accordance with the disclosure;

FIG. 14 is block diagram of an embodiment of a data structure in accordance with the disclosure; and

FIG. 15 is flow chart of an embodiment of a computer implemented method in accordance with the disclosure.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

A system and a method for decreasing the worst case execution time of selected threads are provided herein. Execution of the method by the system facilitates efficient and predictable reversion of lower priority threads, provides predictable bounds for higher priority threads and, if contention occurs, reduces the worst case execution time (WCET) of the higher priority threads. WCET is a metric that determines the maximum length of time a task or set of tasks requires on a specific hardware platform. The method comprises a rollback protocol which provides a more strict predictability guarantee for acquiring a contended resource, because it reduces the latency from the execution time of a low priority thread's critical region to a latency bounded by the unique number of memory locations modified in the region. Effectively, this allows a partition to rollback any direct communication calls made into the partition if those calls acquire shared resources that are required by high priority threads. This allows for more precise and strict WCET guarantees.

Generally, the method is executed by the system. In one embodiment of the system according to the disclosure, the system comprises a processing device, a memory device and a program embedded in the memory device configured to generate resource control instructions. The resource control instructions are configured to control access to a software resource to prevent concurrent access to the software resource by a high priority thread and a low priority thread. The resource control instructions are also configured to store rollback information in a rollback data structure and to rollback the effects of a partly executed low priority thread, using the rollback information, if the high priority thread seeks access to the software resource before the low priority thread completes execution of its critical region. By interrupting execution of the low priority thread and rolling back its effects, the worst case execution time of the high priority thread is improved.

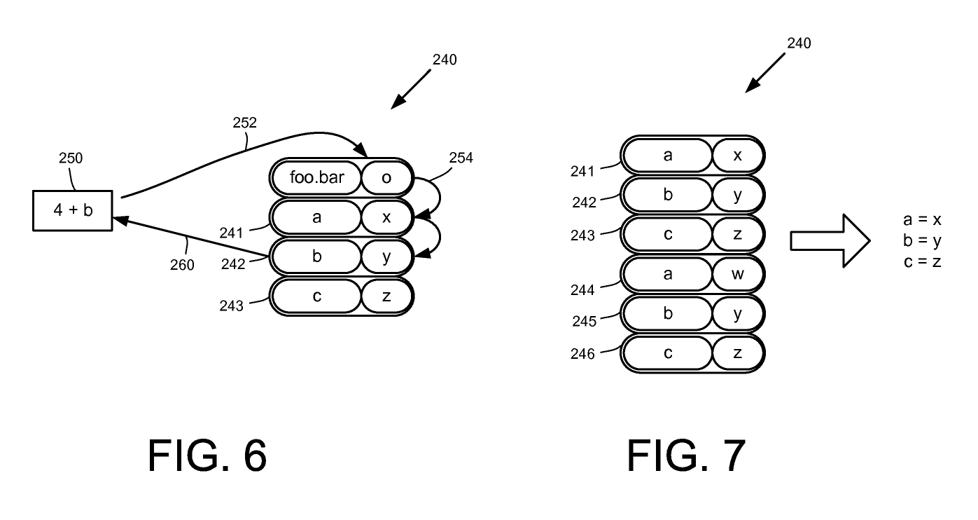

In one variation thereof, modifications to the software resource are stored in the rollback data structure and are written to the software resource once the low priority thread completes execution of its critical region. If the high priority thread seeks access before the low priority thread completes execution of its critical region, the modifications are not written to the software resource so the software resource retains the state it had before the low priority thread begun executing its critical region. Exemplary data structures are disclosed with reference to FIGS. 6, 7 and 14.

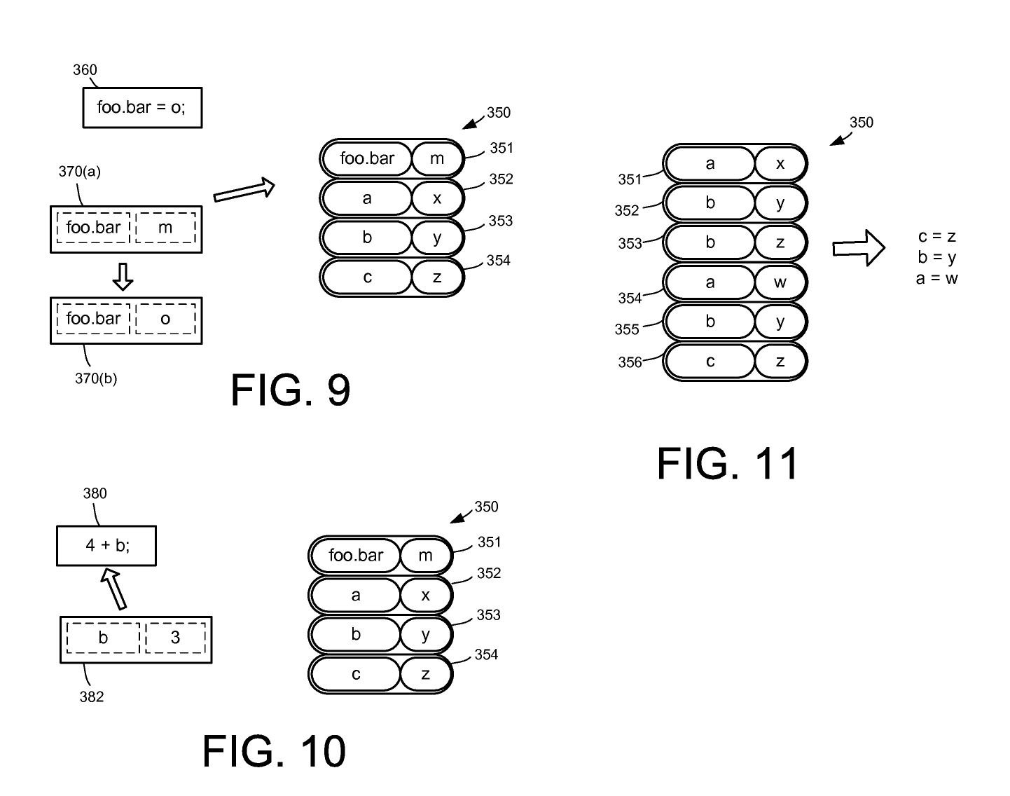

In another variation thereof, modifications are made to the software resource and rollback information is stored in the rollback data structure. If the high priority thread seeks access before the low priority thread completes execution of its critical region, the modifications are rolled back according to the rollback information to return the software resource to the state it had before the low priority thread begun executing its critical region. Exemplary data structures are disclosed with reference to FIGS. 9-11 and 14.

In another embodiment of the system according to the disclosure, the system comprises a support structure, a hardware resource, a processing device and a memory device. A program embedded in the memory device is configured to generate resource control instructions. The resource control instructions are configured to, when executed by the processing device, access a software resource, a rollback data structure and a resource synchronization tool. Acquisition of the resource synchronization tool prevents concurrent access to the software resource. If the resource synchronization tool is free, execution of a lower priority thread causes acquisition of the resource synchronization tool and modification of the rollback data structure with rollback information. If a high priority thread seeks access to the software resource while the resource synchronization tool is acquired due to execution of the lower priority thread, the resource control instructions cause the processing device to release the resource synchronization tool, thereby reducing the WCET of the high priority thread. The support structure supports the hardware resource, the processing device and the memory device. The software resource permits control of the hardware resource. As a result, when control of the resource synchronization tool is taken from the low priority thread, the high priority thread can control the hardware resource without having to wait until the low priority thread executes its critical region.

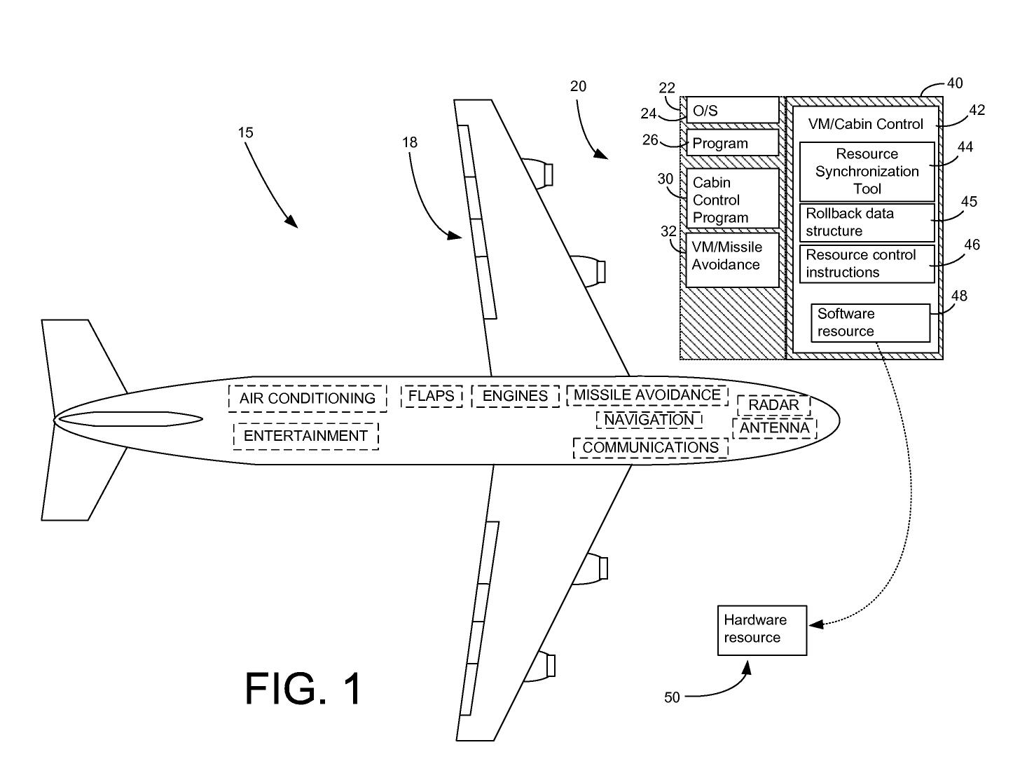

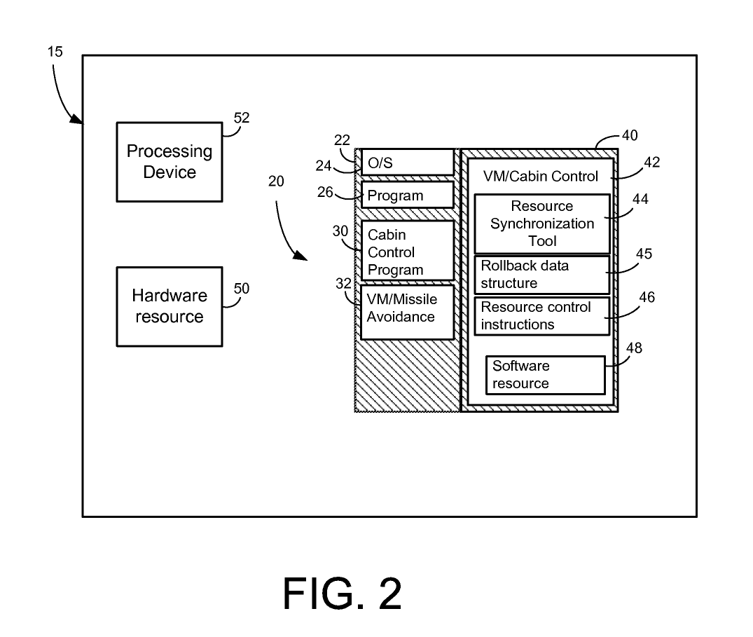

Referring to FIGS. 1 and 2, schematic and block diagrams of another embodiment of a system according to the disclosure are provided therein. The system, denoted by numeral 15, includes a support structure 18, illustratively an airplane, a memory device 20, a hardware resource 50, illustratively an energy source such as a battery, and a plurality of additional hardware systems. Exemplary hardware systems include an entertainment system, flap and engine control systems, navigation, communication and missile avoidance systems, and radar and antenna systems. Memory device 20 is partitioned into a first partition 22 and a second partition 40. First partition 22 has embedded therein an operating system 24, a program 26, a cabin control program 30, and a virtual machine 32 with a runtime instance of a missile avoidance program. Second partition 40 has embedded therein a virtual machine 42 with a runtime instance of a cabin control program including a software resource 48 controlling operation of hardware resource 50, a resource synchronization tool 44, a rollback data structure 45 and resource control instructions 46. Exemplary programs include a compiler, a just-in-time (JIT) compiler and an interpreter. In one example, a programmer codes a program, such as cabin control program 30, to take advantage of the synchronization tool features described herein. Cabin control program 30 generates virtual machine 42. If program 26 is a JIT compiler, when virtual machine 42 executes the cabin control instructions, the JIT compiler generates resource control instructions 46 according to thread management protocols selected and coded by the programmer. The protocols thereby enable the programmer to select an execution modality by applying a protocol without having to code the resource control instructions, which are generated by program 26. In another example, the programmer codes resource control instructions

FIG. 2 is a block diagram of system 15 further comprising a processing device 52. Processing device 52 executes threads from the missile avoidance runtime and the cabin control runtime. The cabin control runtime accesses software resource 48 to control hardware resource 50 and power, for example, the air conditioning system to heat and cool the cabin. At times, the missile avoidance runtime seeks access to software resource 48 to save power, for example. If it is more important to avoid missiles than to develop a comfortable cabin temperature, the missile avoidance thread is assigned higher priority than a thread from the cabin control runtime which is assigned a lower priority. The missile avoidance thread executes more promptly if execution of the cabin control thread is interrupted before it completely executes its critical region. Rollback data structure 44 enables rollback of the critical region of the cabin control thread to return or maintain shared memory contents to or in the condition they were in before execution of the low priority thread critical region begun.

A critical region can be thought of as processing instructions that modify a software resource. If two threads modify the same software resource at the same time, the threads may receive incorrect information and may leave the resource in an inconsistent state. Exemplary software resources include data structures, linked lists, counters, flags, drivers and other software structures configured to modify software resources. Exemplary critical region processing instructions include access instructions, link manipulation instructions, driver blocking and unblocking instructions, instructions that increase or decrease counters and modify flags, and any other instruction that modifies software resources. Synchronization tools are used to provide mutual thread exclusion to reduce the likelihood of such problems. A lock is a type of synchronization tool. When locks are used, the first thread to access the resource acquires the lock governing the resource. Subsequent threads cannot access the resource until the lock is released. Locks mediate exclusive access between threads and can do so by mediating exclusive access to the resource or to a critical region governing the resource. Thus, a critical region is a set of instructions protected by a lock or, generally, by a synchronization tool.

In the present embodiment, the threads have critical regions that contend for access to software resource 48. After the lower priority thread acquires resource synchronization tool 42, it begins executing its critical region. Resource control instructions 45 utilize rollback data structure 44 to ensure that execution of the critical region can be rolled back. If the higher priority thread tries to execute its critical region, at least a part of which is protected by resource synchronization tool 42, resource control instructions 45 roll back execution of the critical region of the lower priority thread and release resource synchronization tool 42 thereby permitting the high priority thread to acquire it. In this manner, resource synchronization tool 42, rollback data structure 44 and resource control instructions 45 cooperate to prevent concurrent access to software resource 48 by the higher priority thread and the lower priority thread and to promptly execute the critical region of the high priority thread to decrease its WCET. Thus, if a cabin control thread has exclusive access to the battery and a missile avoidance thread wishes access, the cabin control thread rolls back execution of its critical region so that the missile avoidance thread can promptly continue executing.

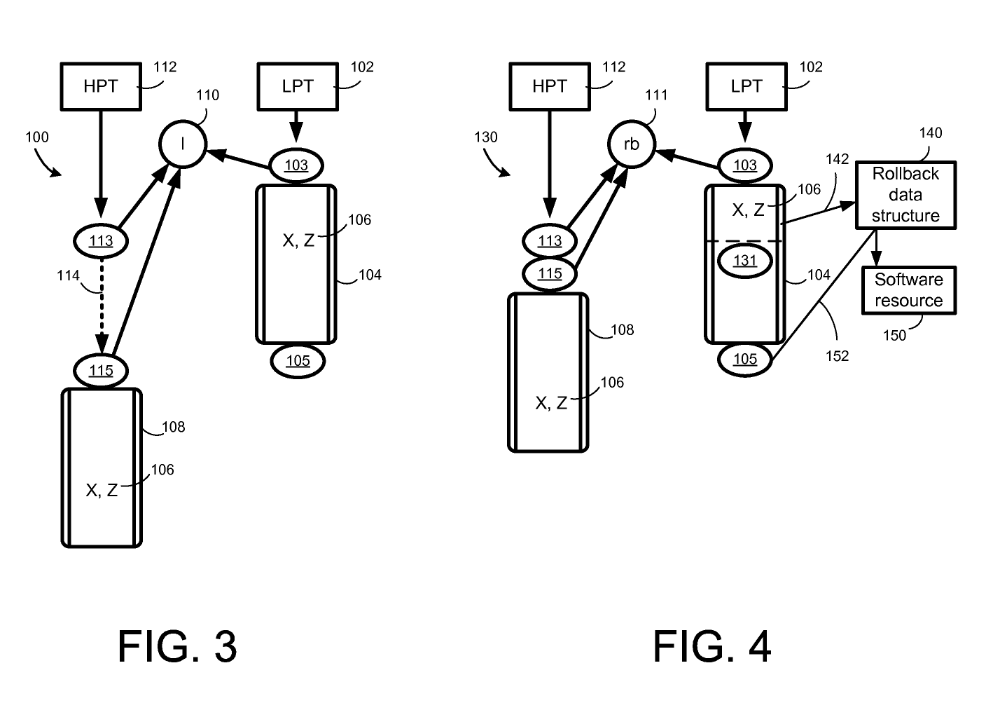

Referring to FIGS. 3 and 4, block diagrams 100 and 130 are provided to illustrate processing of a high priority thread (HPT) 112 and a low priority thread (LPT) 102 without rollback and with rollback, and to illustrate WCET improvements. HPT 112 has higher priority than LPT 102. Referring to FIG. 3, at 103 LPT 102 acquires a synchronization tool 110, illustratively lock I, and then proceeds to execute its critical region 104 which includes instructions to modify parameters 106, illustratively parameters X, Z, which are associated with a software resource. At 105, modification of X or Z therefore controls, at least partially, operation of the software resource. LPT 102 completes execution of its critical region. Sometime between 103 and 105 HPT 112 attempts to acquire lock I, as illustrated at 113, but fails to do so because the lock is held by LPT 102. Simultaneous access to parameters X, Z has been avoided, but HPT 112 must wait a period 114 until lock I is released. At 115, HPT 112 is able to acquire lock I and so processing of critical region 108 of HPT 112 begins.

Referring to FIG. 4, execution of LPT 102 differs from the execution described with reference to FIG. 3 in that at 103, LPT 102 acquires a synchronization tool 111, illustratively a rollback lock rb, before executing its critical region 104. After HPT 112 attempts, at 113, to acquire lock rb, resource control processing instructions roll back, at 131, execution of the executed portion of critical region 104 (denoted by a horizontal dashed line) and, at 115, HPT 112 acquires lock rb without waiting period 114. Thus, priority inversion is avoided. In one example, HPT 112 changes a rollback status indicator of synchronization tool 111, and the resource control instructions in LPT 102 check the rollback status indicator and initiate rollback when the changes is detected. The WCET of HPT 112, which had depended on execution of critical region 104, improved by the amount of execution time required to process the remaining portion of critical region 104 minus the cost associated with the rollback of critical region 104. If execution of critical region 104 were held up by another lock, for example a lock held by a medium priority thread, the WCET of HPT 112 would have improved by the removal of the uncertainty and time associated with execution of the critical region of the medium priority lock as well. In a write buffering mode described further below, modifications to a software resource 150 required by critical region 104 are intercepted and recorded in a rollback data structure 140 as indicated by an arrow 142. At 105, when critical region 104 completed execution, the contents of rollback data structure 140 are flushed to software resource 150. At 131, if rollback is required, the contents of rollback data structure 140 are not flushed; therefore, software resource 150 retains the state it had prior to execution of instructions at 103. In a write logging mode described further below, instruction are first written to software resource 150, and the contents of rollback data structure 140 are used to undo the writes when rollback is performed.

In one variation of the present embodiment, the priority rollback protocol (PRP) described in the present application seamlessly co-exists with current programming models. During programming, the programmer identifies locks which support PRP, determines whether write buffering or write logging is supported, defines thread and application priorities and determines what type of lock or lock modality to use based on the priorities. Interaction with other locking protocols is achieved with extensions so that two critical regions protected by different locks do not affect each other's executions. This allows specialization of software as well as implementation of the rollback protocol in legacy real-time systems. In one example, lock I is a commonly known lock and lock rb is a PRP lock comprising a known lock extended with additional information such as status information which resource control instructions utilize to initiate rollback. Exemplary known locks include priority inheritance protocol (PIP) locks and priority ceiling protocol (PCP) locks.

In one embodiment according to the disclosure, a PRP lock can operate in at least two modes. In a first mode, the lock adheres to a traditional locking mechanism and has the same costs associated with the selected mechanism. In a second mode, the lock is acquired in the rollback mode. Thus, the programmer can choose whether to rollback a critical region, to boost its execution, or to treat a thread in another manner. In one variation, the mode is selected based on the priority of the thread. In one example, the PRP lock operates in the first mode when acquired by a thread having a first priority and in the second mode when acquired by a thread having a second priority. In another example, the first mode is a PIP mode and the second mode is a PRP mode. If a thread with priority higher than the first priority seeks to acquire the lock while it is held by the first priority thread, the resource control instructions implement the PIP protocol. On the other hand, if a thread with priority higher than the second priority seeks to acquire the lock while it is held by the second priority thread, the resource control instructions implement the PRP protocol. A programmer can thus elect to respond to different priorities in different ways to achieve different WCET at different costs.

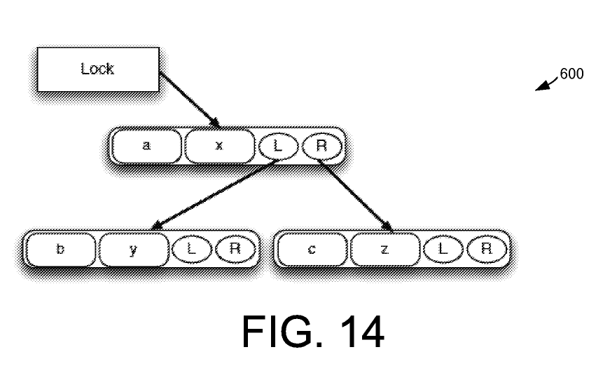

In a further variation of the present embodiment, when an application is assigned a higher priority, its threads are automatically given higher priority than threads from applications with lower priorities. For example, if the missile avoidance system is assigned a high priority and the cabin control system is assigned a low priority, any thread from the missile avoidance system will be able to promptly execute its critical region even when execution contends with execution by a cabin control system thread having a high priority. In a further variation, in addition to prioritizing threads in accordance with the priority of the application generating the threads, the modality of the PRP lock is also selected based on the priority of the application. In one example, if a system such as the entertainment system is assigned the first priority and the cabin control system is assigned the second priority, any thread from the entertainment system will acquire the PRP lock without rollback functionality while the cabin control system acquires the lock in the PRP mode. Selective modality is further described with reference to FIG. 14.

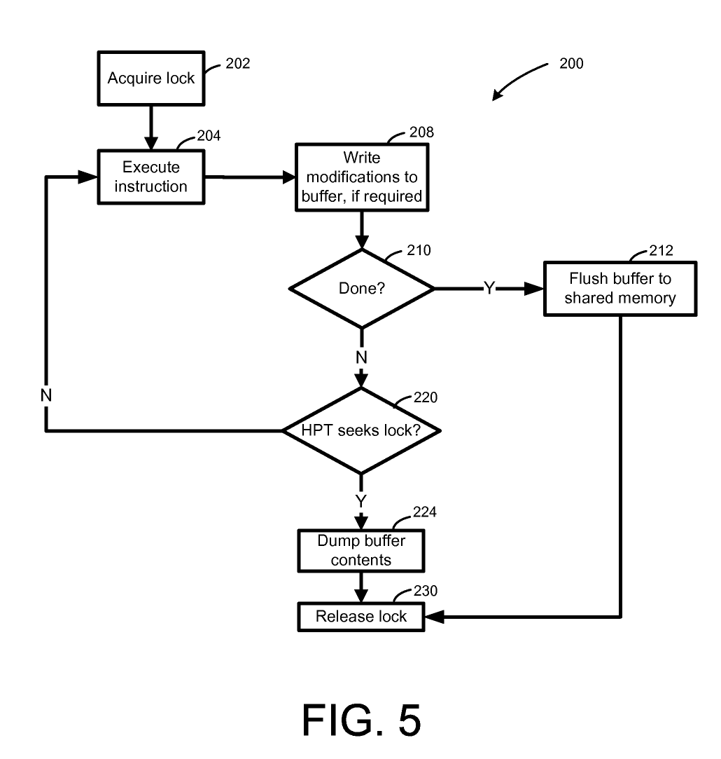

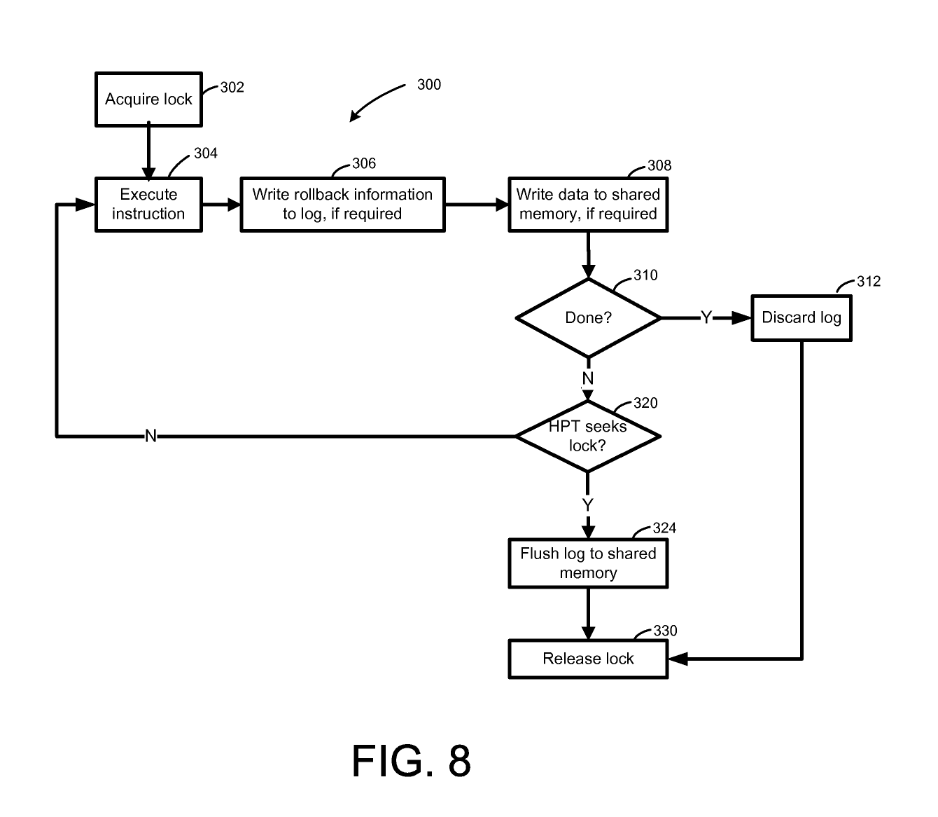

The priority rollback protocol allows for fast and predictable lock acquisition for high priority threads. The priority rollback protocol is optimistic allowing threads to execute speculatively. A thread executes its critical region until a higher priority thread contends for the resource. If no contention exists, execution completes. In one example, writes are performed on a local buffer. If execution completes, the local buffer is flushed to shared memory. In the event of contention, the write buffer is discarded and the critical region is retried. In another example, writes are immediately made to shared memory and, whenever a write is performed, an undo action is logged through the use of a write log. If execution completes, the log is discarded. In the event of contention, the undo actions are executed, thereby reverting shared memory to a state prior to the execution of the critical region. The foregoing exemplary rollback procedures have differing rollback properties and WCET. Exemplary write buffering and logging embodiments are further described with reference to FIGS. 5 and 8.

Implementation of the PRP protocol is not necessarily limited by the selection of applications, programming languages, processing devices or memory devices. Unless otherwise expressly stated in connection with a specific use thereof, the term “device” includes a single device, a plurality of devices, two components integrated into a device, and any variations thereof. The singular form is only used to illustrate a particular functionality and not to limit the disclosure to a single component. Therefore, the term “memory device” includes any variation of electronic circuits in which processing instructions executable by a processing device may be embedded unless otherwise expressly stated in connection with the specific use of the term. For example, the term “memory device” comprises read only memory, random access memory, a field programmable gate array, a hard-drive, a disk, flash memory, and any combinations thereof, whether physically or electronically coupled. Similarly, the term “processing device” comprises, for example, a central processing unit, a math processing unit, a plurality of processors on a common integrated circuit, and a plurality of processors operating in concert, whether physically or electronically coupled. Furthermore and in a similar manner, the term “application” comprises a single application, a plurality of applications, one or more programs or subroutines, software, firmware, and any variations thereof suitable to execute instruction sequences with a processing device.

In a further embodiment of a system according to the disclosure, the priority rollback protocol is implemented in an instance of a virtual machine. A virtual machine (VM), sometimes called an application virtual machine, runs as a normal application inside a system and supports a single process. It is created when that process is started and destroyed when it exits. Its purpose is to provide a platform-independent programming environment that allows a program to execute in the same way on any platform. VMs can be implemented to use interpreters and can be compiled just-in-time to increase performance. Exemplary VMs include Java, Parrot and FIJI virtual machines and the common language runtime (CLR) supporting the .NET framework. The Java VM is distributed by Oracle Corporation. The Parrot VM is distributed by the Parrot Foundation. The FIJI VM is licensed by FIJI Corporation. The CLR is distributed by Microsoft Corporation.

In one variation of the present embodiment, the system described with reference to FIGS. 1 and 2 is a mixed criticality system. Mixed criticality systems are real-time systems in which time, space, and resources are partitioned to ensure one process does not affect the predictability of another process. In one example, the low priority thread is executing a method as a result of a direct communication from one process and the high priority thread is executing a method from another process. The low priority thread acquires a PRP lock. Since PRP allows for the rollback of low priority threads, the high priority thread can initiate a rollback of the low priority thread thereby releasing the PRP lock. Thus, PRP provides a mitigation mechanism to permit cross-process communications.

In one embodiment of a method according to the disclosure, the rollback data structure is a buffer and rollback is performed by not flushing the buffer. In one example, the contents of the buffer are discarded. In another example, the buffer is discarded. In a further example, the buffer is overwritten in a subsequent execution of a critical region requiring the same synchronization tool. Referring to FIG. 5, a flowchart 200 depicting the present embodiment is provided. The embodiment of the method may be performed by the foregoing or hereafter disclosed systems. The method begins at 202, when a thread acquires a lock. At 204, execution of the critical region of the thread begins, whereby statements are executed in turn. If a statement is a write statement or a statement that requires a write, at 208, the locations and values of the write are written to the buffer instead of shared memory. At 210, a determination is made whether execution of the critical region of the thread is completed. In one example, the determination results from an indication from the thread that execution of the critical region is complete. In another example, the determination results from an indication generated by the resource control instructions. If so, at 212, the buffer is flushed to shared memory. In one example described further below, resource control instructions including flushing instructions are inserted into a copy of the critical region by a JIT compiler. The resource control instructions include read and write barriers as well as the instructions to flush the buffer when execution of the critical region is complete. After flushing the buffer, at 230, resource control instructions release the lock. Otherwise, processing continues.

At 220, resource control instructions check whether a higher priority thread seeks to acquire the lock so that it can execute its critical region. In one example, also described further below, the PRP lock includes a status bit that the higher priority thread can set to indicate that it is seeking the lock. If the higher priority thread seeks the lock at 220, resource control instructions dump the contents of the buffer at 224 and release the lock at 230. If the higher priority thread does not seek the lock, processing continues at 204. Because the higher priority thread interrupts execution of the thread, priority inversion is avoided and the attendant benefits are achieved. Another benefit is that the re-execution time of the critical portion of the low priority thread is now known.

In one example, the resource control instructions create a new version of the code for the critical region and add read and write barriers. The barriers redirect read and write actions to the buffer. Every write to shared memory is stored within the write buffer. Each read from a location that is stored in the buffer must read the latest value from the buffer. At a high-level, a write buffer can be implemented as a stack of location and value pairs. The location is the raw memory address of the data being written to, and the value is the value that the thread wishes to write. The WCET of a write is, therefore, the cost of creating the pair and pushing it onto the write buffer stack. A read on the other hand, must do a check to see if an object is present in the write buffer. The WCET of a read is, therefore, the cost to traverse the buffer.

Referring to FIGS. 6 and 7, block diagrams of buffer operations are described in connection with a buffer 240 including location and value pairs 241-246. Each pair includes a location and a value stored in the location. Referring to FIG. 6, a WCET calculation will now be described using the stack analogy. When a thread executes a statement foo.bar=o; in a critical region protected by a PRP lock, a new location and value pair containing foo.bar and o is pushed onto the write buffering stack. When a read statement 4+b; is executed, denoted by numeral 250, the resource control instructions check to see if a value is stored for location b in buffer 240. Checking is indicated by arrow 252. This requires traversing the write buffer, as indicated by arrows 254. If a location and value pair is found for location b, the value in the first such pair is read, as indicated by arrow 260. The first pair contains the logically last write to the location b. In FIG. 7, buffer 240 contains two entries for each of locations a, b and c. When flushing, the buffer is traversed top down. The first entry for location a is in value pair 241; therefore, the value x is pushed to location a in shared memory. Similarly, value y is written to location b in accordance with value pair 242 and the value z is written to location c in accordance with value pair 243. The writes associated with value pairs 244-246 are intermediate writes and, since they occurred within a critical region, no other thread can observe those values. The values flushed to shared memory are a=x; b=y and c=z.

In another example, the buffer is flushed by walking its write buffer stack and for every location and value pair, writing the value to the location. The cost of flushing a buffer in this manner is the cost to traverse the buffer and perform the writes.

In a further example, the process of flushing is accelerated by flushing only the logically last write to a given location. Therefore, if a low priority thread writes to a given location many times, only the last value written is written to shared memory. The cost of flushing a buffer in this manner includes the cost of processing to track, while traversing the buffer, which writes are the last writes to each location. Cost savings relative to the previous example may result depending on the critical region.

Although, PRP slows down the low priority thread while it executes its critical region, it allows high priority threads wishing to acquire the lock to unroll low priority threads. If a low priority thread is in the process of executing its critical region, a high priority thread can signal the low priority thread to stop its execution and immediately acquire the lock. This is safe because the low priority thread has buffered all of its changes to shared state. Therefore, memory is consistent with a state in which the low priority thread has not executed the critical region. The WCET of acquiring the lock when the low priority thread is executing its critical region is the cost of signaling the thread and acquiring the lock.

In a yet further example, an additional bit of information is reserved in the PRP lock to signal that a thread which acquired a lock in rollback mode is in the process of flushing its buffer. Therefore, if a high priority thread seeks access to the software resource when the low priority thread is in the process of flushing its buffer, i.e. in the middle of updating shared state, flushing is allowed to complete. In one example, the flushing operation is boosted to speed up release of the lock. The WCET of acquiring the lock when a low priority thread is flushing its buffer is the cost to flush the buffer, effectively in the order of the number of writes to the critical region.

In another embodiment of a method according to the disclosure, the rollback data structure is a log and rollback is performed by flushing the log. Referring to FIG. 8, a flowchart 300 depicting the present embodiment is provided. The embodiment of the method may be performed by the foregoing or hereafter disclosed systems. The method begins at 302, when a thread acquires a lock. At 304, execution of the critical region of the thread begins, whereby statements are executed in turn. If a statement is a write statement or a statement that requires a write, at 306, the location and current value of the write are written to the log and, at 308, the new value is written to shared memory. At 310, a determination is made whether execution of the critical region of the thread is completed. In one example, the determination results from an indication from the thread that execution of the critical region is complete. In another example, the determination results from an indication generated by the resource control instructions. If so, at 312, the log is discarded and then, at 330, the lock is released. In one example, resource control instructions, including write barriers, are inserted into a copy of the critical region by a JIT compiler. Otherwise, processing continues.

At 320, resource control instructions check whether a higher priority thread seeks to acquire the lock so that it can execute its critical region. If the higher priority thread seeks the lock, at 324, resource control instructions flush the log to shared memory to revert the previous modifications and, at 330, the resource control instructions release the lock. If the higher priority thread does not seek the lock at 320, processing continues at 304.

One difference between write logging and buffering is the data stored in the log. Instead of storing the location and the value to be updated, the write log instead stores the location and the value that existed prior to the write. The write then happens to shared memory. Therefore, a write log can be viewed as the inverse of the critical region and provides a way to restore the state of memory to one existing prior to the execution of the critical region. A benefit of utilizing a write log over a write buffer is that the read barrier can be omitted. The read barrier can be omitted because the write proceeds to main memory and therefore any subsequent reads to the same location are valid. The WCET of a read in the write logging version of PRP is simply the cost of the read itself. Another benefit is that there is no need to flush when a thread completes its critical region, because a successful completion of the critical region yields the correct state of memory. Each write performed in the critical region is propagated to main memory. The write log can, thus, simply be discarded and the memory reclaimed.

A write barrier is still necessary even though the write occurs to main memory since a copy of the old value must be stored in the write log. Therefore, prior to a write, a location and value pair is pushed onto the stack of the write log. The value is the value currently held in the location. After the old value has been logged, the write proceeds as normal. The WCET of a write in the write logging version of PRP is the cost of a normal write as well as the cost of adding the location and value pair to the write log. Referring now to FIGS. 9 and 10, block diagrams of logging operations are described in connection with a log 350. Referring to FIG. 9, on every write to shared memory, the location currently held in the destination is stored within the write log which acts as a stack of location value pairs. Block 370(b) represents a shared memory location before a thread executes a statement 360, illustratively foo.bar=o, in a critical region protected by a PRP lock, and block 370(a) represents the shared memory location after the thread executes statement 360. Thus, when statement 360 is executed, a new value for foo.bar is stored in shared memory, in this case o, and the prior value of foo.bar, in this case m, is pushed to log 350 into location and value pair 351. Location and value pairs 352-356 are location and value pairs written from previously executed instructions. Referring to FIG. 10, each read from a given location reads directly from main memory. Block 382 represents a shared memory location before a thread executes a statement 380, illustratively 4+b;, in a critical region protected by a PRP lock. When statement 380 is executed, the value of b, in this case 3, is read directly from shared memory and not from log 350.

As described with reference to FIG. 8, when a high priority thread wishes to acquire a lock that is held by a lower priority thread, the log must be flushed to main memory. In other words, since the state of memory is inconsistent with that prior to the execution of the critical region by the lower priority thread, the high priority thread must revert the writes done by the low priority thread. The cost of doing so is the cost of performing one write for each location and value pair stored in the log. In one example, only one write, correspond to the logically earliest location value pair held in the log for a given location, is necessary to revert the state of memory. Referring to FIG. 11, location and value pairs 351 and 354 contain values associated with location a. Location and value pair 354 contains the earliest value of location a; therefore, when log 350 is flushed the values z , y, and w for locations c, b, and a are written to shared memory. In one example, log 350 is traversed bottom up.

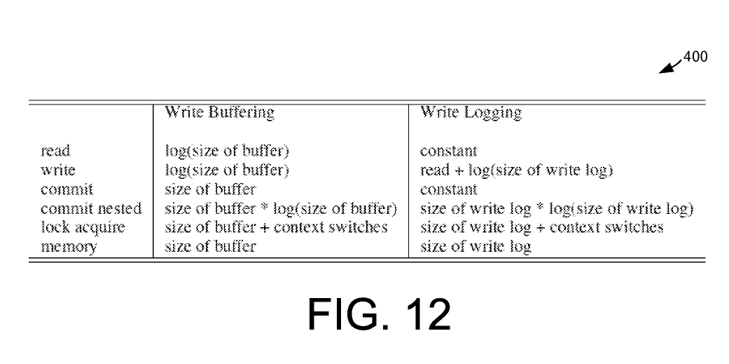

Write buffering and write logging have a number of differences and tradeoffs. Referring to FIG. 12, a table 400 is provided to illustrate the complexity costs of both approaches. In table 400, the size of the buffer and log are both proportional to the number of unique memory locations modified by the critical region. Therefore, a region that is read-only, will have constant time complexity for all of its operations. In addition to differing in complexity, both approaches differ in safety guarantees on the sate of memory. Since all writes occur in a buffer under the write buffering approach to PRP, main memory is always in a consistent state. Any unprotected reads to locations that are modified within the critical region protected by a write buffering PRP lock will always see consistent values. On the other hand, since write logging allows writes to update shared memory, unprotected reads may see incorrect values if and only if a critical region protected by a write logging PRP lock is rolled back.

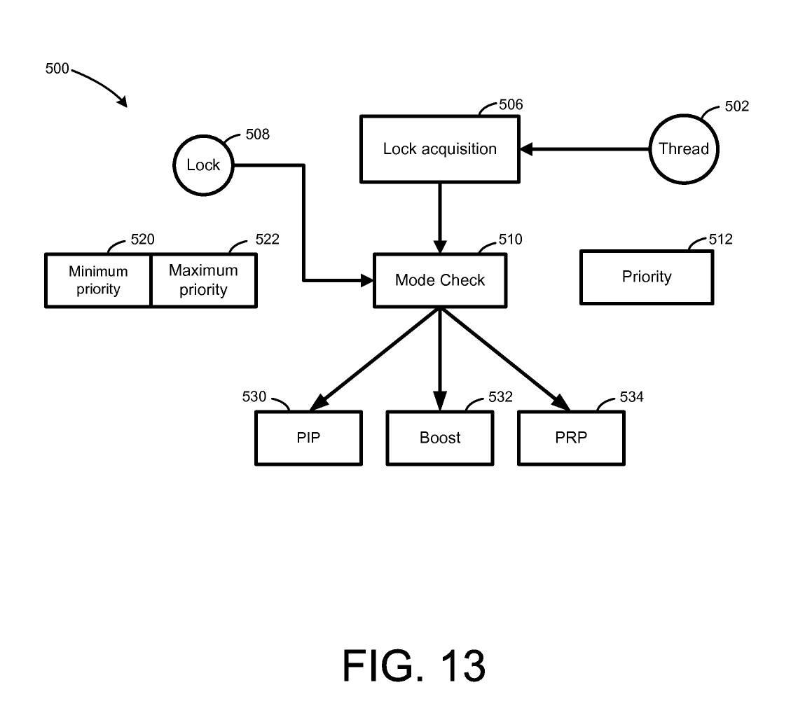

In one embodiment of a system according to the disclosure, the lock has a maxPriority and minPriority and the mode in which the lock is acquired is determined by the relationship between the priority of the acquiring thread, the minPriority and the maxPriority. In the present embodiment, when acquiring a PRP lock, a thread first determines the mode in which the lock is acquired. This is done based on the priority of the thread and the maxPriority and minPriority of the PRP lock. If the priority of the acquiring thread is less than minPriority, then the lock is acquired in PRP mode and the thread can be rolled back. If the priority of the acquiring thread is greater than or equal to minPriority but also less than or equal than the maxPriority, then the thread's priority is boosted to maxPriority. If the priority of the acquiring thread is strictly greater than maxPriority, then the PIP governs operation of the lock. A block diagram, denoted by numeral 500, depicting an embodiment of a method implemented with the foregoing system is shown in FIG. 13. At 506, a thread 502 seeks to acquire a lock 508. Lock 508 has a minimum priority 520 and a maximum priority 522. Thread 502 has a priority 512. At 510, resource control instructions compare priority 512 to the minimum priority 520 and maximum priority 522. Depending on the outcome of the comparison, thread 502 may acquire lock 508 in a PRP mode 534, a boost mode 532 and a PIP mode 530. If priority 512 is less than minimum priority 520, thread 502 acquires lock 508 in PRP mode 534. If priority 512 is equal to or greater than minimum priority 520 but less than maximum priority 522, thread 502 acquires lock 508 in boost mode 532. Otherwise, thread 502 acquires lock 508 in PIP mode 530. The foregoing embodiment comprises a lock with three modes defined by a minimum and a maximum value but such definition is only exemplary. In another example, the lock only has two modes of operation defined by the minimum priority. In a further example, the lock has four or more modes of operation defined by three or more priority levels.

As described above, a known lock is extended with one or more words to create a PRP lock and to keep track of the lock's status and meta-data. Exemplary meta-data includes maximum and minimum priorities, as described with reference to FIG. 13, a status bit configured to indicate that rollback is required, a status bit to indicate that the buffer is flushing, a pointer to the rollback data structure, an embedded rollback data structure and a mode bit indicating the mode in which the lock was acquired, as described with reference to FIG. 13. Exemplary resource control instructions include acquire and release statements augmented with additional checks reflecting use of specialized methods and critical sections. Rather than performing the same checks multiple times, specialized methods and critical sections are used to statically compile a program based on known priorities of systems, programs, threads and synchronization tools. In a Java application for example, multiple versions of the synchronized method are generated to account for lock modalities. Similarly, multiple versions of critical regions protected by a PRP lock are generated. In one example, a specialized critical region is created for threads which acquire the lock but do so in a fashion where the write buffer is not required (e.g. the thread's priority is greater than or equal to minPriority of the lock). In another example, a specialized critical region is generated to support write buffering. The write buffering version of the code contains read and write barriers to all locations read and written and code to flush the buffer at the end of the method/region. In a further example, a specialized critical region is generated to support write logging. The write logging version of the code contains write barriers and code to flush the log during rollback. In an even further example, a specialized method determines, based on the outcome of conditional statements, whether to apply write buffering or write logging critical regions.

In a further embodiment according to the disclosure, the priority rollback protocol is implemented in the FIJI VM. FIJI VM is an ahead-of-time compiler that transforms Java bytecode into fast ANSI C code. Thus, FIJI VM runs on any platform that has a C compiler, threads, and locks. It does not require a memory management unit since null-checks and sync-points do not rely on protection-based mechanisms. FIJI VM runs on many operating systems including Linux, Darwin, NetBSD, the Real Time Executive for Multiprocessor Systems (RTEMS) and systems having real-time embedded micro-kernels. RTEMS is used for very hard safety-critical tasks, including both ESA and NASA missions. FIJI VM runs on many hardware architectures including x86, PowerPC, and LEON. FIJI VM deliberately omits features such as virtual memory and processes, dynamic memory allocation, and other unpredictable operating system facilities. Additionally, the FIJI VM employs a variety of techniques for ensuring that the generated C code obeys Java semantics, and permits accurate stack maps for scanning by the garbage collector. FIJI VM utilizes an Immix-style on-the-fly concurrent real-time garbage collector as well as Schism. Additionally, the FIJI VM has extensive support for mixed criticality systems, providing both time and space partitioning at the VM level. In this embodiment, PRP locks support the same interfaces as other Java locks and critical regions are demarcated with the synchronized keyword.

Referring to FIG. 14, a block diagram 600 of a red/black tree according to one variation of the rollback data structure is provided. Due to its inherent constraints, the red/black tree is efficient in its worst case time. The red/black tree implementation can also be more space efficient than an equivalent stack implementation. Although conceptually simple, stacks are not space efficient when a critical region writes to a given memory location many times. In such situations, the stack has one entry in the write buffer or write log for each write performed in the critical region (see FIG. 7). By contrast, the red/black tree holds precisely one element per unique memory location. A comparative execution using a stack, shown in FIG. 7, contains six separate entries. In one variation, the red/black tree is utilized by an application which also implements a non-moving garbage collector. In one example, the application is the FIJI VM. Utilizing a red/black tree provides a space efficient implementation vessel for both versions of PRP. Similarly, the red/black tree reduces WCET and complexity bounds to the number of unique memory locations written in a critical region. The red/black tree implementation of the write buffer contains on one entry for the memory locations a, b, and c,

In another embodiment according to the disclosure, the write buffer is implemented as a red/black tree. The write buffer stores the location being written to as well as the value being written. In addition to this information, each entry in the buffer contains a bit to signify color, either red or black, and two pointers for the left and right child of the tree. The red/black tree, with the pointers, is effective when objects are not moved. The size of the buffer can be limited statically through annotations on the region itself. If the buffer is statically limited and this limit is exceeded at runtime, a runtime exception is thrown. The size of the buffer is proportional to the number of unique memory locations written to during the execution of a critical region. If the buffer is not limited, it will contain precisely one entry for every unique location written to during the execution of the critical region protected by the write buffering PRP lock. Critical regions which are read only or update a fixed constant number of locations will have constant time complexity for operations whose complexity depends on the size of the write buffer.

The design of write buffering and write logging share many commonalities including lock layout and acquisition, code generation, and irrevocable actions among others. Write logging requires additional properties to guarantee safety. Since memory is updated by a thread which may potentially be reverted, all locations protected by a critical region are always protected by that region.

In one example, read and write barriers are inserted by a compiler for all locations read and written during the execution of a critical region protected by a PRP lock. A read barrier abstractly must first check if the location being read has been written to prior in the critical region. If this is the case, then the correct value to be read will be stored in the write buffer itself and not main memory. Therefore, a read barrier first checks to see if the location being read is in the buffer. This corresponds to a red/back tree lookup based on the location. If the lookup fails, then the location has not been written to prior in the critical region and the correct value is stored in main memory. The worst case execution of a read barrier is thus a red/black tree lookup followed by a read. The cost of the read barrier is the cost of the read plus the log of the size of the buffer.

A write barrier is simply a red/black tree insertion. If the location has already been written to, the new value written simply overwrites the current value stored in the red/black tree. This operation will not cause the tree to be re-balanced. The cost of a write barrier is log of the size of the buffer.

When the critical region has been completed, the writes stored in the write buffer are flushed to main memory. Before flushing to main memory, the thread notifies the lock by setting the meta-data field in the lock that it is committing. Once this has been completed, the red/black tree is traversed and for each node the value that is stored is written to the location also stored in the node. The worst case execution time to flush the buffer is proportional to the size of the buffer.

There are a number of actions a thread may perform that may not be able to be unrolled, such as I/O operations. Attempting to perform an irrevocable action while holding a PRP lock results in a runtime exception. Acquiring a regular lock while holding a PRP lock is also considered an irrevocable action as the subsequent nested lock acquisition does not support a rollback.

When a PRP lock is acquired by a thread which already holds a PRP lock, a new buffer is created. Reads and writes in this critical region operate over this new buffer. By using separate buffers for each nested PRP lock acquisition, each lock can be rolled back without requiring the rollback to the outermost PRP lock. For nested critical regions, the read barrier is slightly more complicated as values being read may have been written during the execution of outer critical regions. Therefore, a read must check the buffer of an outer region if the location is not present in the red/back tree of the inner most critical region. The write barrier remains unchanged. When a nested critical region completes, the two write buffers are merged. This is an n log(n) operation, where n is the size of the larger tree, as it requires merging both red/black trees.

In a further embodiment according to the disclosure, the write log is implemented as a red/black tree. On a write, the log stores the location being written to as well as the value previously held by that location. In addition to this information, each entry in the log contains a bit to signify color, either red or black, and two pointers for the left and right child of the tree. The key for the red/black tree is the location being written to. Therefore, the write log contains information to undo the writes that occurred in the critical region protected by the PRP lock. The write log, similarly to the write buffer, contains one location and value tree entry for every uniquely modified location within the critical region protected by the write logging PRP lock.

Before writing to shared memory, write barriers check to see if the location being written to is already stored in the log. If the location already exists in the log, the value is written to main memory and the log remains unchanged. This happens because the log already contains an entry for that location and thus has all the information necessary to restore that location to a state prior to the execution of the critical region. If the location is not present in the log, the current value held in that location is read and a new node is created for the location. This node is then inserted into the red/black tree. Therefore, the worst case execution of the write barrier is a red/black tree lookup, followed by a read and a red/back tree insertion, and lastly followed by a write. The cost of a write is the cost of a read, plus a write, plus log of the size of the red/black tree. In the write logging scheme of PRP, read barriers are not necessary since all updates occur to main memory. When the critical region has been completed, the write log is discarded. This is a constant time operation.

In one example, to roll back a low priority thread currently executing within the critical region, the acquiring thread signals the lower priority thread to flush its log. Once the log has been flushed, the acquiring thread then immediately acquires the lock. The state of main memory is that of main memory prior to the acquisition of the lock by the lower priority thread. The worst case execution time for acquisition is therefore the cost of signaling and context switching to the lower priority thread, the cost of flushing the log, and then switching back to the higher priority thread. The cost of flushing the log is the size of the red/black tree, which is in the order of the number of unique memory locations written to during the critical region of the lower priority thread.

In a further embodiment according to the disclosure, if the underlying VM is configured to utilize garbage collection (GC) as a memory management scheme, the write buffer or write log may contain the last reference to a given object. In a write logging PRP scheme, this can occur when a thread has the last reference to an object o and overwrites that reference with some other object m. The write log will contain an entry that points to o although the program itself does not. Until the given critical region completes, those objects cannot be garbage collect. The same can occur under a write buffering scheme. Consider if a thread performs a write to a reference to object o. Main memory does not change, and an entry that contains o is added to the write buffer. If all other threads overwrite their references to o then the write buffer will contain the last references to o. Therefore, whenever a thread must scan its stack for its root set, it must also add the objects in its write buffer or write log to that set.

The FIJI VM utilizes arrayelets to prevent fragmentation of memory. An array is composed of an immutable spine and know sized mutable array chunks. Exemplary spines and arrays are described in detail with reference to garbage collection methods and systems in U.S. patent application No. 12/564,691 titled “HYBRID FRAGMENTING REAL TIME GARBAGE COLLECTION” filed on Sep. 22, 2009, the entire disclosure of which is expressly incorporated herein by reference. In the FIJI VM, arrayelet spines are the only objects that can be moved by the garbage collector. When a thread writes to an array within a critical region protected by a PRP lock, nothing special needs to happen since the array chunks are never moved in memory. The garbage collector ensures that writes to objects which point to arrays (spines which can be moved) are handled correctly. When the GC modifies pointers to the immutable spines it must also do so for any pointers to a spine contained in the write buffer or write log.

Embodiments of a method and a system according to the disclosure were described with reference to exemplary data structures and synchronization tools to illustrate the functionality of the priority rollback protocol. Appropriate resource control instructions are determined by the selection of the programming language, the data structures and the synchronization tools. For example, the Java language facilitates implementation of synchronization tools such as locks using synchronize statements. The Java language also facilitates insertion of read and write barriers. However, implementation of the priority rollback protocol functionality is not limited to the Java language. The foregoing embodiments can also be implemented with other programming languages such as C++ and any other language suitable for defining data structures, synchronization tools, and signaling between threads or processing sequences to coordinate access to software resources utilizing the synchronization tools and the data structures. Furthermore, while in some embodiments the resource control instructions were inserted in threads or in copies of critical sections of threads, the priority rollback protocol functionality can also be implemented using other signaling techniques to direct processing of threads or processing sequences to coordinate access to software resources utilizing the synchronization tools and the data structures.

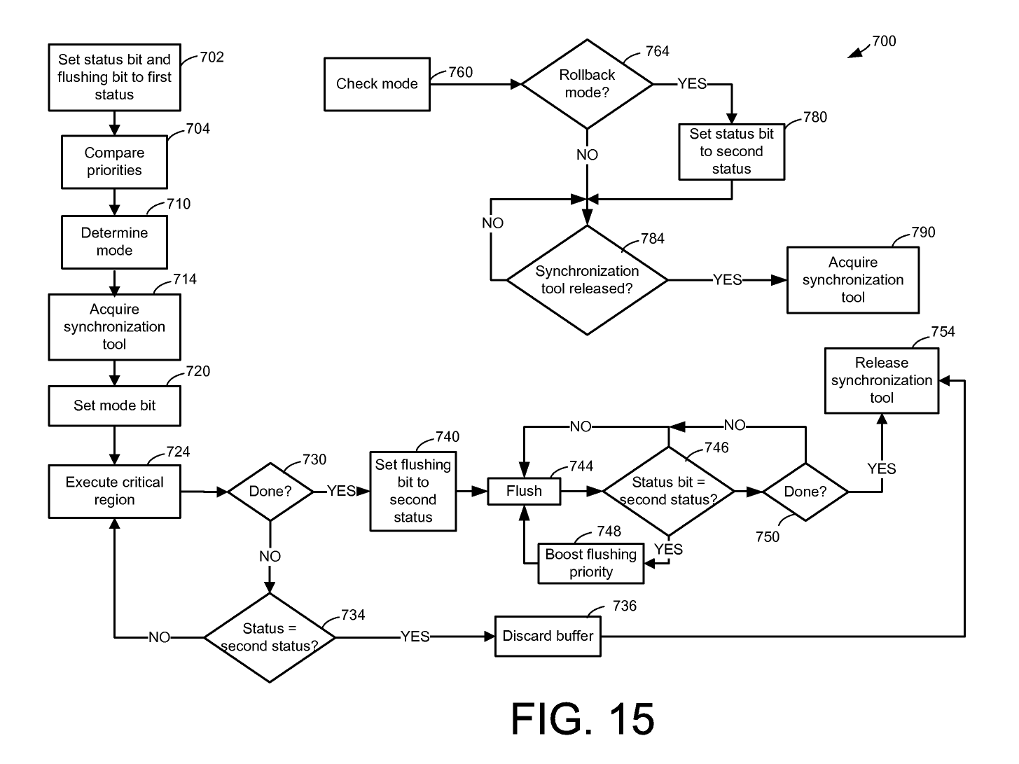

Referring now to FIG. 15, a method performed by a plurality of processing sequences according to another embodiment of the disclosure is provided. In another embodiment according to the disclosure, a non-transitory computer readable medium is provided having the processing sequences embedded therein. The method will be illustrated with reference to a flowchart 700 in connection with a rollback protocol with buffering. In the method, a first and a second processing sequences potentially contend for a software resource. In this exemplary embodiment, the first processing sequence has a lower priority than the second processing sequence. At 702, the first processing sequence sets a status bit and a flushing bit to a first status. The first status indicates that a synchronization tool protecting a critical region of the first processing sequence has not been acquired by another processing sequence. The second status indicates that the synchronization tool has been acquired, in which case the first processing sequence waits. The flushing bit first status indicates that flushing is not occurring and the second status indicates that flushing begun. At 704, the first processing sequence compares its priority to the minimum priority of the synchronization tool. At 710, the first processing sequence compares determines, based on the comparison, whether the synchronization tool can be acquired in rollback mode. At 714, the first processing sequence acquires the synchronization tool and, at 720, sets the mode bit. If the synchronization tool can be acquired in rollback mode, the mode bit is set to indicate rollback mode.

At 724, the first processing sequence executes its critical region. As described previously, in one example specialized critical regions are provided including resource control instructions. In another example, the resource control instructions are included in a specialized method. In a further example, the resource control instructions are included in the first processing sequence. It should be understood that the first processing sequence is described herein in connection with the described instructions. However, the first processing sequence can also be described in the context of a plurality of processing sequences, each being smaller than the first processing sequence and together performing the function of the first processing sequence. In one example, the first processing sequence is a first thread and the second processing sequence is a second thread.

At 730, the first processing sequence determines whether the critical region completed execution. In one variation, when execution of the critical region is complete, at 740 the first processing sequence sets the flushing bit to the second status to prevent the second processing sequence from accessing the software resource mid-flushing. At 744, flushing begins. At 746, the first processing sequence tests the status bit to determine if the second processing sequence seeks access to the software resource. If the status bit equals the second status at 746, the first processing sequence boosts the flushing priority at 748. Otherwise, flushing continues at 744. At 750, the first processing sequence tests whether flushing is completed. If so, at 754 the first processing sequence releases the synchronization tool. If not, flushing continues at 744.

If at 730 the first processing sequence determines that execution of the critical region is not complete, at 734 it tests the status bit to determine if the second processing sequence seeks access to the software resource. If the status bit equals the second status at 734, the first processing sequence discards the buffer at 736. Otherwise, execution of the critical region continues at 724. In one example, the synchronization tool includes the boundaries of the critical region, and the determination at 730 comprises comparing the current instruction to the boundaries of the critical region. In another example, another status bit is provided along with a resource control instruction configured to switch the status bit when processing reaches the resource control instruction, and the status of the status bit is checked to determine that processing of the critical region has completed.

Referring now to the second processing sequence, at 760 and 764 the second processing sequence checks the mode in which the synchronization tool was acquired by the first processing sequence. If acquired in the rollback mode at 714, the second processing sequence switches the status bit at 780 to indicate to the first processing sequence to rollback and release the synchronization tool. At 784, the second processing sequence determines whether the synchronization tool was released. If so, at 790, it acquires the synchronization tool and proceeds to execute its critical region.

In one example, a third processing sequence is provided for writing rollback information to a rollback data structure based on the first processing sequence's execution at 724. In another example, the rollback data structure is incorporated with the synchronization tool.

The terms first, second and third are arbitrary and merely distinguish different processing sequences. The foregoing method can also be described as having a first processing sequence and a second processing sequence, the second processing sequence having the lower priority and the first processing sequence switching the status bit to cause the second processing sequence to rollback. It should also be understood the rollback protocol has been described using exemplary terms for illustration purposes only and that the same functionality can be described using different terminology, as required by the programming language used to implement the protocol. Further, the invention encompasses combinations of the features described above to implement the rollback protocol.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method executable with a processing device according to processing instructions embedded in a non-transitory computer readable medium to prevent concurrent access to a software resource by a first thread and a second thread, the method comprising:
executing a critical region of the first thread;
writing rollback information to a rollback data structure based on the executing of the critical region of the first thread;
detecting an indication that the second thread seeks access to the software resource; and
after detecting the indication, rolling back the executing of the critical region of the first thread.

2. A method as in claim 1, further comprising the step of controlling operation of a hardware resource with the software resource.

3. A method as in claim 1, wherein the first thread has a lower priority than the second thread, and wherein rolling back the executing of the critical region reduces a worst case execution time of the second thread.

4. A method as in claim 1, wherein the rollback data structure is a buffer and the step of rolling back the executing of the critical region of the first thread includes releasing a synchronization tool without flushing the buffer.

5. A method as in claim 4, further comprising the steps of flushing the buffer and modifying a status indicator of the synchronization tool to indicate that flushing begun, wherein if flushing begun before the indication is detected in the detecting step, the second thread cannot access the software resource until the flushing step is complete.

6. A method as in claim 1, wherein the rollback data structure is a log and the step of rolling back the executing of the critical region of the first thread includes flushing the log.

7. A method as in claim 1, further comprising the steps of comparing a priority of the first thread to a minimum priority of a synchronization tool and permitting the step of rolling back the executing of the critical region if the priority of the first thread is less than the minimum priority.

8. A method as in claim 7, wherein the synchronization tool is a lock configurable to operate in at least two modes selected from a priority inheritance protocol mode, a priority ceiling protocol mode, a boost mode and a priority rollback mode, further comprising the step of configuring the lock to operate in one of the at least the two modes based upon the priority of the first thread, the minimum priority and the maximum priority.

9. A method as in claim 1, wherein the critical region comprises a portion of the first thread protected by a synchronization tool and configured to modify the software resource.

10. A method executable with a processing device according to processing instructions embedded in a non-transitory computer readable medium to prevent concurrent access to a software resource by a first processing sequence and a second processing sequence, the method comprising:
executing the first processing sequence with the processing device;
writing rollback information to a rollback data structure based on the first processing sequence;
detecting an indication that the second processing sequence seeks access to the software resource; and
after detecting the indication, rolling back the executing of the first processing sequence.

11. A method as in claim 10, wherein rolling back the executing of the first processing sequence reduces a worst case execution time of the second processing sequence.

12. A method as in claim 10, wherein the rollback data structure is a buffer and the step of rolling back the executing of the first processing sequence includes releasing a synchronization tool without flushing the buffer.

13. A method as in claim 12, further comprising the steps of flushing the buffer and modifying a status indicator of the synchronization tool to indicate that flushing begun, wherein if flushing begun before the indication is detected in the detecting step, the second processing sequence cannot access the software resource until the flushing step is complete.

14. A method as in claim 10, wherein the rollback data structure is a log and the step of rolling back the executing of the first processing sequence includes flushing the log.

15. A method as in claim 10, further comprising the steps of comparing a priority of the first processing sequence to a minimum priority of a synchronization tool and permitting the step of rolling back the executing of the first processing sequence if the priority of the first processing sequence is less than the minimum priority.

16. A non-transitory computer-readable medium operable by a processing device to prevent concurrent access to a software resource by a first processing sequence and a second processing sequence, the non-transitory computer-readable medium comprising a plurality of processing sequences embedded therein including:
a third processing sequence configured for writing rollback information to a rollback data structure based on execution of the first processing sequence;
a fourth processing sequence configured for detecting an indication that the second processing sequence seeks access to the software resource; and
a fifth processing sequence configured for rolling back the execution of the first processing sequence after detecting the indication.

17. A computer-readable medium as in claim 16, further including a sixth processing sequence configured for controlling operation of a hardware resource based on the software resource.

18. A computer-readable medium as in claim 16, wherein rolling back the execution of the first processing sequence reduces a worst case execution time of the second processing sequence.

19. A computer-readable medium as in claim 16, wherein the rollback data structure is a buffer and rolling back the execution of the first processing sequence includes releasing a synchronization tool without flushing the buffer.

20. A computer-readable medium as in claim 16, wherein the rollback data structure is a log and rolling back the execution of the first processing sequence includes flushing the log.

21. A computer-readable medium as in claim 16, further including a sixth processing sequence configured to generate a seventh processing sequence including a portion of the first processing sequence which is protected by a synchronization tool and configured to modify the software resource, the third processing sequence, the fourth processing sequence and the fifth processing sequence.

22. A computer-readable medium as in claim 16, further including a sixth processing sequence configured to append to the first processing sequence the third processing sequence, the fourth processing sequence and the fifth processing sequence.

23. An system configured to prevent concurrent access to a software resource, the system comprising:
a support structure;
a hardware resource supported by the support structure;
a processing device supported by the support structure, the processing device adapted for executing a first processing sequence and a second processing sequence;
a non-transitory computer-readable medium supported by the support structure; and
a plurality of processing sequences embedded in the non-transitory computer-readable medium including
a third processing sequence adapted for writing rollback information to a rollback data structure based on the first processing sequence;
a fourth processing sequence configured for detecting an indication that the second processing sequence seeks access to the software resource; and
a fifth processing sequence configured for rolling back the execution of the first processing sequence after detecting the indication.

24. A system as in claim 23, further comprising a synchronization tool having a first status bit, the first status bit having a first status when the second processing sequence seeks access to the software resource and a second status otherwise.

25. A system as in claim 23, further comprising a synchronization tool having a rollback status bit, the rollback status bit having a first rollback status when the first processing sequence acquires the synchronization tool in a rollback mode and a second rollback status otherwise.

26. A system as in claim 23, further comprising a sixth processing sequence and a synchronization tool having a flushing status bit, the rollback data structure comprising a buffer, the sixth processing sequence configured to flush the buffer and to change the flushing status bit from a first flushing status to permit the rolling back to a second flushing status to prevent the rolling back.
